(19) United States
(12) Patent Application Publication
(10) Pub. No.: US 2025/0044602 A1
(43) Pub. Date: Feb. 6, 2025

(54) OPTICAL MODULE WITH TILTED-PLANE OPTICAL PATHS

(71) Applicant: Lumentum Operations LLC, San Jose, CA (US)

(72) Inventor: Li FAN, Milpitas, CA (US)

(21) Appl. No.: 18/535,488

(22) Filed: Dec. 11, 2023

Related U.S. Application Data
(60) Provisional application No. 63/517,033, filed on Aug. 1, 2023.

(51) Int. Cl. G02B 27/14

(52) U.S. Cl. CPC G02B 27/14

(57) ABSTRACT

In some implementations, an optical component includes a substrate component; and a plurality of mirrors disposed on a top surface of the substrate component in a single, horizontal plane, wherein each mirror, of the plurality of mirrors, is angled, non-orthogonally, with respect to the single, horizontal plane, such that each optical path associated with each mirror is disposed in a corresponding tilted plane that is non-parallel with the single, horizontal plane.

### CROSS-REFERENCE TO RELATED APPLICATION

This patent application claims priority to U.S. Provisional Patent Application No. 63/517,033, filed on Aug. 1, 2023, and entitled “OPTICAL MODULE WITH NON-HORIZONTAL SPATIAL BEAM COMBINING.” The disclosure of the prior application is considered part of and is incorporated by reference into this patent application.

### TECHNICAL FIELD

The present disclosure relates generally to optical modules and to an optical module with tilted-plane optical paths for non-horizontal spatial beam combining.

### BACKGROUND

Optical systems, such as laser systems, may incorporate collections of two or more optical emitters, such as laser diodes. The optical emitters may be used as a direct source of output laser radiation, or as a pump for a diode-pumped laser, such as a fiber laser, a disk laser, a slab laser, a rod laser, a diode-pumped solid-state laser, a Raman laser, a Brillouin laser, an optical parametric laser, or an alkali-vapor laser, among other examples. In some laser applications, such as in fiber laser pumping, materials processing, graphic arts, medical lasers, remote power generation, pyrotechnic ignition, measurement, sensing, or communication, among other examples, beams of light, provided by the two or more laser diodes may be combined to generate, for example, a single high-power and/or high-quality output beam.

### SUMMARY

In some implementations, an optical component includes a substrate component; and a plurality of mirrors disposed on a top surface of the substrate component in a single, horizontal plane, wherein each mirror, of the plurality of mirrors, is angled, non-orthogonally, with respect to the single, horizontal plane, such that each optical path associated with each mirror is disposed in a corresponding tilted plane that is non-parallel with the single, horizontal plane.

In some implementations, an optical module includes a substrate; a plurality of mirrors disposed on a top surface of the substrate, wherein each mirror, of the plurality of mirrors, is angled with respect to a plane of the top surface of the substrate, such that each optical path associated with each mirror is disposed in a corresponding tilted plane that is non-parallel with and non-orthogonal to the plane of the top surface of the substrate; and one or more optical components to form a set of optical paths that includes each optical path associated with each mirror.

In some implementations, an optical component includes a base; and a plurality of mirrors disposed on the base in a single, horizontal plane, wherein each mirror, of the plurality of mirrors, is angled, non-orthogonally, with respect to the single, horizontal plane, such that each optical path associated with each mirror is disposed in a corresponding tilted plane that is non-parallel with the single, horizontal plane, and wherein each optical path, associated with each mirror, is parallel to each other optical path.

### BRIEF DESCRIPTION OF THE DRAWINGS

FIGS. 1A-1C are diagrams of an example of an optical module with stepped-plane optical paths.

FIG. 2 is a diagram of an example implementation associated with an optical component with tilted-plane optical paths.

FIG. 3 is a diagram of an example implementation associated with an optical module with tilted-plane optical paths.

FIG. 4 is a diagram of an example implementation associated with an optical module with tilted-plane optical paths.

### DETAILED DESCRIPTION

The following detailed description of example implementations refers to the accompanying drawings. The same reference numbers in different drawings may identify the same or similar elements.

A laser system may include a beam combiner configured to perform beam combining. For example, the beam combiner may be configured to combine beams launched by a group of laser sources (e.g., a group of laser diodes, a laser array, or a set of vertical cavity surface emitting lasers (VCSELs)) in order to generate a single output beam (or a plurality of output beams that are each comprised of a plurality of combined beams). The use of a scalable beam-combining technology may allow for a power-scalable laser source (e.g., even when the individual laser sources are not scalable).

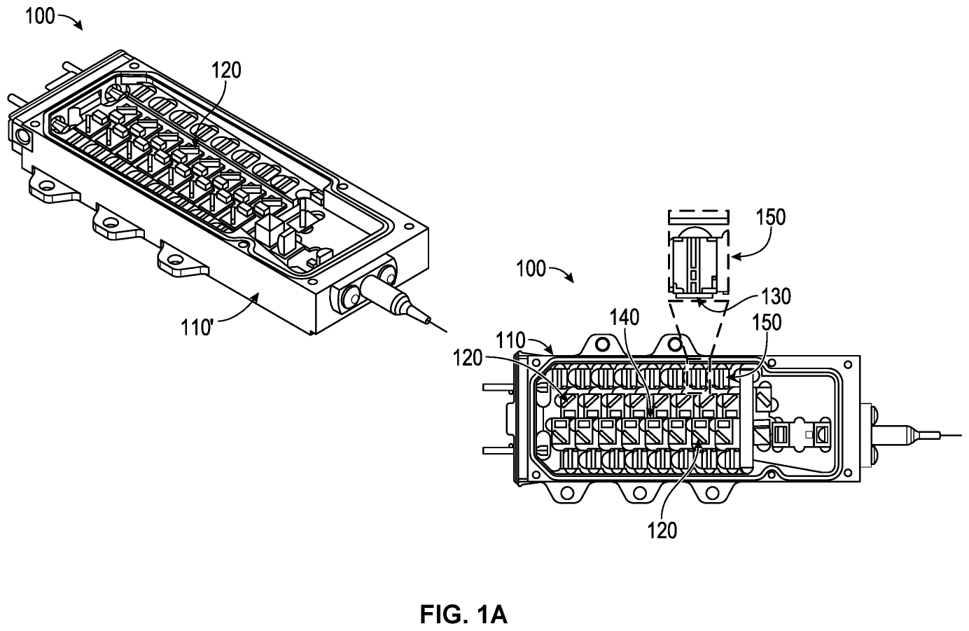

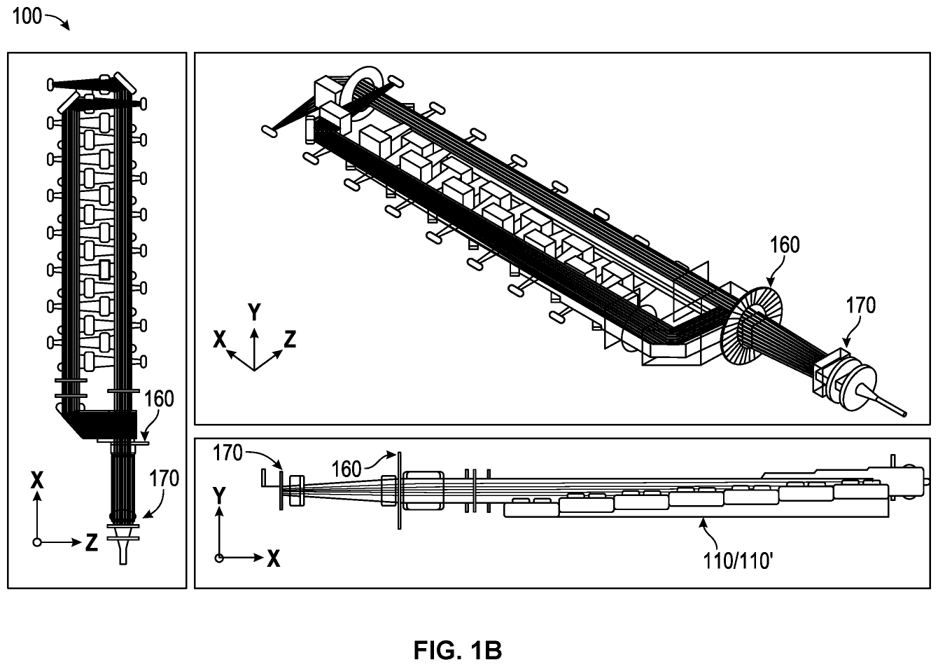

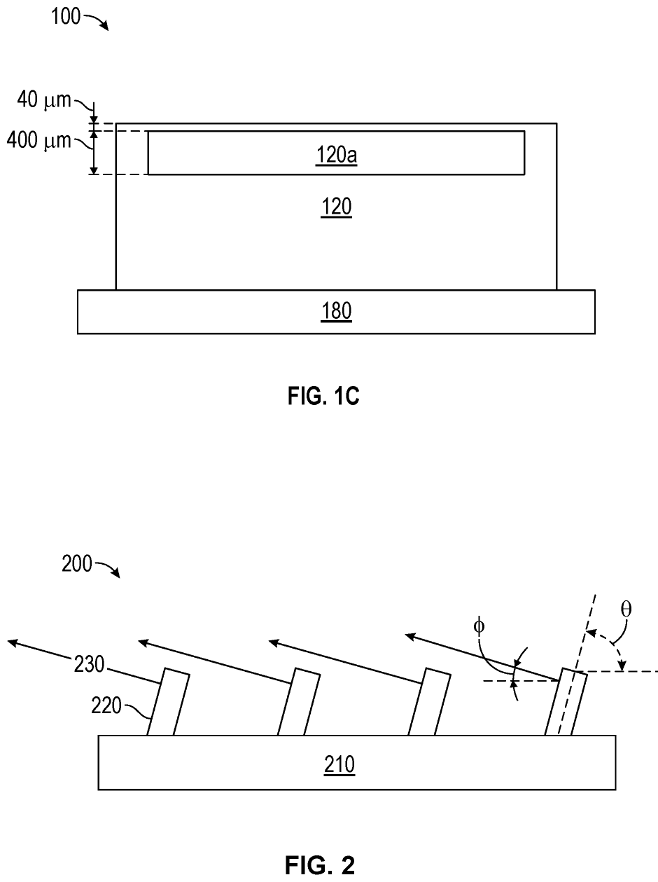

FIGS. 1A-1C are diagrams of an example 100 of an optical module with stepped-plane optical paths. As shown in FIG. 1A, a multi-chip pump module 110 may include a set of folding mirrors 120, a set of fast axis collimator (FAC) lenses 130, and a set of slow axis collimator (SAC) lenses 140. Each FAC lens 130 is aligned to a chip on submount (COS) component 150.

Each COS component 150 may be mounted at different step heights above a base 110′ of the multi-chip pump module 110. Accordingly, when each COS component 150 outputs a respective optical beam, each respective optical beam is output on a different plane. The optical beams may be collimated by the FAC lenses 130 and the SAC lenses 140. The optical beams may be reflected by the set of folding mirrors 120 and directed in a horizontal plane, such that each of the optical beams is parallel to each other optical beam before reaching a coupling FAC lens 160 and a coupling SAC lens 170, shown in FIG. 1B.

However, the step height between different folding mirrors 120 (and associated COS components 150) may limit a quantity of COS components that can be included in the multi-chip pump module 110. In other words, the housing of the multi-chip pump module 110 can accommodate a limited quantity of steps, resulting in a limited quantity of COS components 150 mounted on the limited quantity of steps. Reducing a step height could enable additional COS components to be included in the housing; however, smaller step heights may result in adjacent folding mirrors 120 blocking beams associated with other COS components 150. In other words, when a step height between a first COS component 150 and a second COS component 150 is less than a threshold amount, a first folding mirror 120 associated with the first COS component 150 may block a beam directed from the second COS component 150 (toward a second folding mirror 120 associated with the second COS component 150).

Furthermore, with each step having a different thickness to achieve a different height above a base of a housing of the multi-chip pump module 110, each step may have a different thermal path. The different thermal paths for each step may result in differential heat transfer between different COS components 150. Accordingly, different COS components 150 may experience temperature differentials of greater than 5 degrees C. (° C.) or greater than 10° C., among other examples. The differences in operating temperatures for different COS components 150 may reduce output power, may reduce device reliability, or may limit a module spectral linewidth, among other examples, resulting in poor volume Bragg grating (VBG) wavelength stabilization.

To avoid beam blocking, and as step height is reduced, beams can be precisely directed toward only an uppermost area of a folding mirror 120, which is disposed on or attached to a substrate 180, as shown in FIG. 1C. For example, a beam may be directed toward an area 120a, which may have a height of approximately 400 micrometers (μm) and which may be only approximately 40 μm from a top of the folding mirror 120. A misalignment of a FAC lens 130 with a folding mirror 120 may result in an optical beam failing to be directed toward the area 120a, resulting in either blocking by another mirror 120 (e.g., when the optical beam is directed below the area 120a) or transmission over the folding mirror 120 (e.g., when the optical beam is directed above the area 120a). In both cases, an optical module may experience power loss as a result of the misalignment. Accordingly, it may be desirable for a spatial beam combiner to be configured without stepping for COS components and/or associated folding mirrors.

As indicated above, FIGS. 1A-1C are provided as an example. Other examples may differ from what is described with regard to FIGS. 1A-1C.

Some implementations described herein provide for an optical module with tilted-plane optical paths. For example, an optical component may include a set of COS components aligned to a set of mirrors that are mounted at an angled orientation relative to a top surface of a substrate. In this case, each mirror, of the set of mirrors, reflects a corresponding beam at an angle to the top surface of the substrate (e.g., neither parallel nor orthogonal to the top surface of the substrate), thereby enabling the corresponding beam to pass over one or more other mirrors rather than being blocked by the one or more other mirrors. Accordingly, the set of mirrors can be mounted to the top surface of the substrate without stepping. By mounting the set of mirrors to the top surface of the substrate without stepping (or with reduced stepping), the optical component may enable a greater density of COS components and corresponding mirrors to be disposed within a housing than occurs with stepping. Additionally, or alternatively, the COS components may be associated with the same thermal path, thereby resulting in a reduced temperature differential between COS components, which may improve power, reliability, and/or module spectral linewidth. Additionally, or alternatively, the COS components may be aligned to the set of mirrors with a reduced tolerance, as a greater proportion of a surface of a mirror may be used for reflecting a beam without power loss occurring relative to when stepping is used.

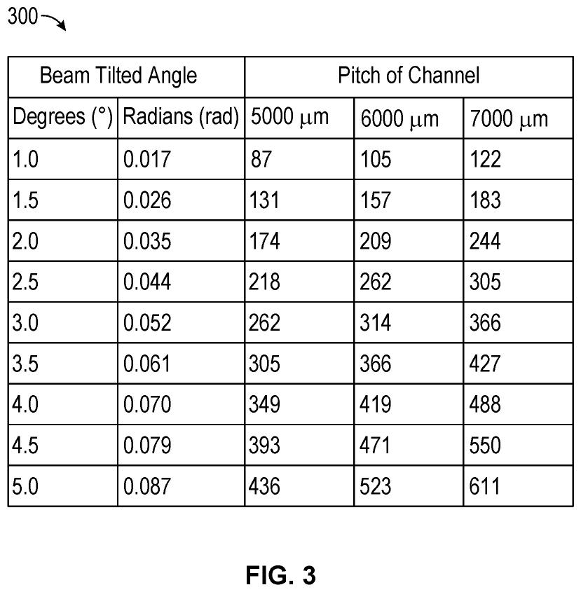

FIGS. 2 and 3 are diagrams of an example optical component 200 associated with tilted-plane optical paths. As shown in FIG. 2, the optical component 200 includes a substrate 210 and a set of mirrors 220. In some implementations, the optical component 200 may be included in an optical module, which may have a housing, inputs, outputs, or other electrical or optical elements, among other examples, as described in more detail herein. Additionally, or alternatively, the optical module may be included in an optical system, such as an optical communications system, an optical measurement system, an optical manufacturing system, or another type of system.

The substrate 210 may include a package body, a ceramic substrate, a submount, or another surface to which one or more other components can be mounted. For example, the substrate 210 may be a base onto which the set of mirrors 220 are mounted. In this case, the substrate 210 may be associated with one or more other bodies that form one or more other sides of the package body. In other words, an optical component 200 may have a package enclosure that includes a base, and the set of mirrors 220 may be mounted to the base of the package enclosure, which may serve as a heat sink. Additionally, or alternatively, the set of mirrors 220 may be mounted to a different side of the package enclosure. Additionally, or alternatively, the set of mirrors 220 may be mounted to a different body within the package enclosure. For example, a heat sink component may be mounted to the base of the package enclosure, and the set of mirrors 220 may be mounted to the heat sink component. Additionally, or alternatively, one or more other layers of material or components may be provided, such as a material layer that is disposed on or attached to the base of the package enclosure to enable the set of mirrors 220 to be mounted to the base of the package enclosure (e.g., an adhering layer or epoxy layer).

In some implementations, the set of mirrors 220 are mounted to a top surface of the substrate 210 (e.g., the base of the package body, a heat sink component, or another material layer or component) without stepping. For example, the set of mirrors 220 are mounted in the same plane along the top surface of the substrate 210, rather than in a set of parallel planes corresponding to steps associated with the top surface of the substrate. In some implementations, one or more other components may be mounted to the substrate or in alignment with the set of mirrors 220 on the substrate 210. For example, a set of COS components (not shown) may be mounted on the substrate 210 or on another body that is aligned with the substrate 210 to enable the set of COS components to be aligned to the set of mirrors. In some implementations, the substrate 210 may be a submount of a COS component or the submount of the COS component may attach to the substrate 210. Additionally, or alternatively, a set of lenses (e.g., SAC lenses or FAC lenses) or other optical elements may be mounted to the substrate 210 or in alignment with the substrate 210.

The set of mirrors 220 may be mounted to the substrate 210 at a first angle θ with respect to a plane of the top surface of the substrate 210. For example, the set of mirrors 220 may be angled such that each mirror 220 is not coplanar with or orthogonal to the top surface of the substrate 210. In this case, the set of optical paths 230 may be directed, based on reflecting off the set of mirrors 220, at a second angle ϕ with respect to the plane of the top surface of the substrate 210.

In some implementations, each mirror 220 may have the same angle with respect to the top surface of the substrate 210, resulting in a set of parallel optical paths 230. Alternatively, one or more mirrors 220 may have different angles resulting in non-parallel optical paths 230. In some implementations, the set of mirrors 220 may include one or more folding mirrors. For example, a mirror 220 may be mounted to the top surface of the substrate 210 in an alignment to achieve a folded optical path, which allows an optics footprint reduction relative to a configuration without folding mirrors.

In some implementations, another type of beam tilting optical component may be mounted to substrate 210 (e.g., in addition to or in place of the set of mirrors 220). For example, the optical component 200 may include a set of tilted lenses, a set of offset lenses, or a set of diffractive optical elements (DOEs), among other examples. Additionally, or alternatively, rather than an optical element being mounted at a tilt relative to a top surface of the substrate 210, the substrate 210 may be manufactured to have a set of tilted facets to which the set of mirrors 220 are mounted. In this case, each mirror is mounted to the tilted facets, resulting in the beam paths being tilted with respect to a non-tilted portion of the substrate 210 (e.g., a bottom of the substrate 210 or a portion of the substrate 210 between the tilted facets). Similarly, a set of tilted bases may be mounted to the substrate 210 and the set of mirrors 220 may be mounted, without a tilt, to a top of the set of tilted bases, resulting in the set of mirrors 220 being tilted with respect to the top surface of the substrate 210. Other types of tilting mechanical or optical structures or components are contemplated to achieve a beam path 230 that propagates at a tilting angle such that beams are not blocked by other mirrors 220 of a set of mirrors 220 and thereby reducing a height of stepping between mirrors 220 or obviating a need for any stepping between mirrors 220.

In some implementations, one or more parameters of the mirrors 220 may be configured to avoid beam blocking by other mirrors 220 (e.g., to ensure that a beam path 230 associated with a mirror 220 does not intersect with any other mirror 220). For example, a size of the mirrors 220 may be selected to avoid beam blocking by other mirrors 220. Additionally, or alternatively, a position of the mirrors 220 may be selected to avoid beam blocking by other mirrors 220. Additionally, or alternatively, a tilting angle of the mirrors 220 may be configured to avoid beam blocking by other mirrors 220. Additionally, or alternatively, the tilting angle of the mirrors 220 may be configured to achieve at least a threshold area that is usable to provide an optical path 230. For example, as described above, a portion of a mirror 220 may be blocked (e.g., result in an optical path that is incident thereon being blocked); however, the tilted mirror 220 may achieve a larger available area (e.g., another portion of the mirror 220 that does not result in an optical path that is incident thereon being blocked).

In some implementations, the set of optical paths 230 may be directed non-horizontally. For example, based on an angle of each mirror of the set of mirrors 220, each corresponding optical path 230 may be directed at a tilting angle (e.g., a non-orthogonal angle) relative to the top surface of the substrate 210. The tilting angle may be associated with a pitch of each channel. For example, as shown in Table 300 of FIG. 3, a 6000 micrometer (μm) pitch channel may use a beam tilted angle of 5 degrees (°) to achieve a beam height separation (Δ) of 523 μm. In some implementations, a minimum beam height separation of 400 μm may be used to avoid beam blocking. Accordingly, as shown in Table 300 of FIG. 3, a 5000 μm pitch channel may have a minimum tilting angle of 5°, a 6000 μm pitch channel may have a minimum tilting angle of 4°, and a 7000 μm pitch channel may have a minimum tilting angle of 3.5°.

In some implementations, a beam may be directed in both a horizontal plane and a non-horizontal plane associated with an optical path 230. For example, the beam may be collimated by a FAC and a SAC and directed along a horizontal plane toward a mirror 220, which may redirect the beam along a non-horizontal plane of the optical path 230.

In some implementations, one or more other optical elements may be provided in the optical component 200 or in an optical module that includes the optical component 200. For example, the optical component 200 (or an optical module) may include a folding mirror, a polarization beam combiner, a coupling FAC, a coupling SAC, or fiber bulkhead, among other examples that may be tilted in the same orientation as the optical paths 230. In this case, an optical module may include the substrate 210, a set of optical emitters (e.g., COS components or other chips for emitting a beam) the set of mirrors 220, FAC lenses and SAC lenses associated with each optical emitter for each optical beam that is to be combined, a spatial beam combiner, a wavelength locked module, a volume Bragg grating (VBG), a fiber bulkhead, a FAC lens and SAC lens to focus a combined beam, or an output (e.g., a port or fiber output), among other examples. In some implementations, the optical component 200 may have one or more non-tilted optical elements.

In some implementations, an optical module that includes one or more optical components 200 may be divided into a set of banks (e.g., sets of emitters, mirrors 220, etc. on one or more substrates 210 or chips within a common assembly or package). For example, the optical module may include a first bank with a first set of COS components mounted at a first height and a second bank with a second set of COS components mounted at a second height (e.g., that may be different than the first height). In this case, the first bank may include a first set of mirrors 220, SAC lenses, etc. mounted at the first height, and the second bank may include a second set of mirrors 220, SAC lenses, etc. mounted at the second height. In this case, although the first bank may have a different height from the second bank (e.g., relative to a base of a package), there is no stepping within a single bank (e.g., among COS components and mirrors 220 of a single bank), which enables each bank to be manufactured within a smaller package. Additionally, or alternatively, the optical module may have one or more components that are shared by the first bank and the second bank, such as one or more common folding mirrors, a common polarization beam combiner, a common, coupling FAC, a common, coupling SAC, or a common fiber bulkhead, which may each be tilted at a common tilting angle with the set of optical paths 230. In some implementations, each bank may use a fork structure (e.g., in which the two sets of folding mirrors are offset from each other, as shown) for arranging optics therein, which may enable a reduction in channel pitch (e.g., from 7000 μm to 5000 μm), which may enable a greater density of COS components and associated mirrors 220 within an assembly (e.g., and without increasing a beam path length for end channels).

By avoiding increasing the beam path length for end channels, the assembly may avoid beam blocking by an aperture (e.g., an opening on a module package housing in which a bulkhead can be mounted) and maintain power within a configured numerical aperture. By increasing a density of COS components and associated mirrors 220 that can be included in a single assembly, the single assembly may achieve a higher power level than other assemblies of optical modules. By maintaining each COS component and associated mirror 220 (e.g., of a single bank) at a single, common height (e.g., with the same thickness of substrate 210 thereunder), the optical component 200 achieves higher consistency of thermal resistance, thereby enabling a reduction in thermal differentiation between different COS components and associated mirrors 220, which improves performance (e.g., by reducing variation in lasing wavelength of each channel).

As indicated above, FIGS. 2 and 3 are provided as examples. Other examples may differ from what is described with regard to FIGS. 2 and 3. The number and arrangement of devices shown in FIGS. 2 and 3 are provided as an example. In practice, there may be additional devices, fewer devices, different devices, or differently arranged devices than those shown in FIGS. 2 and 3. Furthermore, two or more devices shown in FIGS. 2 and 3 may be implemented within a single device, or a single device shown in FIGS. 2 and 3 may be implemented as multiple, distributed devices. Additionally, or alternatively, a set of devices (e.g., one or more devices) shown in FIGS. 2 and 3 may perform one or more functions described as being performed by another set of devices shown in FIGS. 2 and 3.

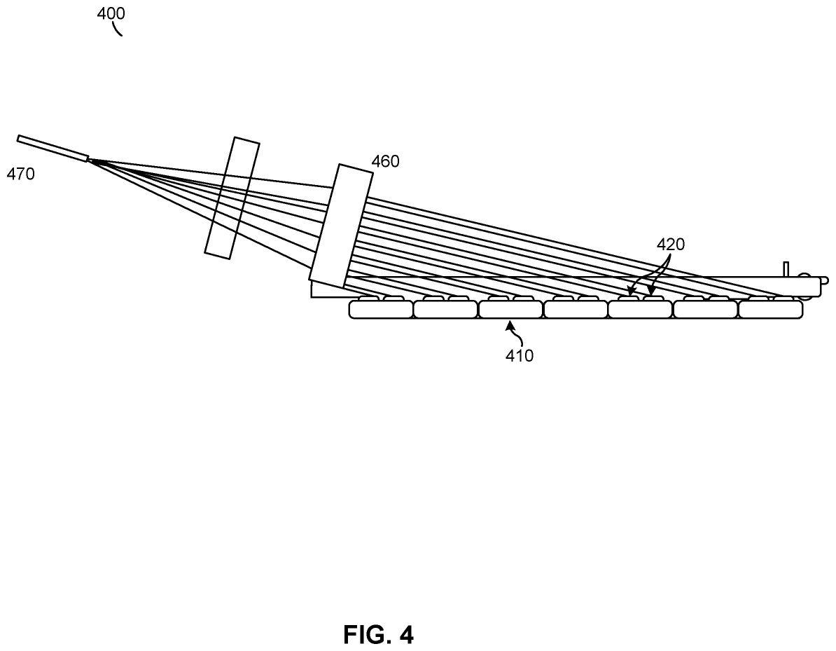

FIG. 4 is a diagram of an example 400 of an optical module with tilted-plane optical paths.

As shown in FIG. 4, a multi-chip pump module 410 may include a set of folding mirrors 420, which are tilted relative to a plane of the multi-chip pump module 410. As shown, the folding mirrors 420 may be arranged in two banks, which are offset from each other. It is contemplated that other quantities of banks may be possible, such as a single bank and/or that other arrangements may be possible, such as a non-offset arrangement. When each folding mirror 420 reflects a respective optical beam, each respective optical beam is reflected on the same tilted plane. The optical beams may be parallel to each other optical beam before reaching a coupling FAC lens 460 and a coupling SAC lens. The optical beams may converge at a fiber bulkhead 470.

In some implementations, the coupling FAC lens 460 and/or one or more other optical components may be tilted, such that beams are incident on the coupling FAC lens 460 at a normal angle (e.g., the coupling FAC lens 460 is oriented on a tilted plane of the set of folding mirrors 420). In other words, rather than the coupling FAC lens 460 (and other optical elements) being oriented vertically, as is shown, the coupling FAC lens 460 may be oriented at an angle to receive the beams at a normal angle. Using folded mirrors 420 arranged on a tilted plane, rather than step heights, to achieve different, non-obstructed paths for the optical beams enables a greater density of beams (and associated transmitting components) to be provided using a single multi-chip pump module 410.

As indicated above, FIG. 4 is provided as an example. Other examples may differ from what is described with regard to FIG. 4.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical component, comprising:
a substrate component; and
a plurality of mirrors disposed on a top surface of the substrate component in a single, horizontal plane,
wherein each mirror, of the plurality of mirrors, is angled, non-orthogonally, with respect to the single, horizontal plane, such that each optical path associated with each mirror is disposed in a corresponding tilted plane that is non-parallel with the single, horizontal plane.

2. The optical component of claim 1, further comprising:
a plurality of optical emitters aligned to the plurality of mirrors and configured to emit a corresponding beam along a corresponding optical path toward the plurality of mirrors for reflection along the titled plane.

3. The optical component of claim 1, wherein the plurality of mirrors are folding mirrors.

4. The optical component of claim 1, wherein a first optical path associated with a first mirror, of the plurality of mirrors, is in a first tilted plane and a second optical path associated with a second mirror, of the plurality of mirrors, is in a second tilted plane that is parallel to the first tilted plane.

5. The optical component of claim 1, wherein a size of the plurality of mirrors and an angle of the plurality of mirrors with respect to the single, horizontal plane is configured such that each optical path associated with each mirror does not intersect with any other mirror of the plurality of mirrors.

6. The optical component of claim 5, wherein a mirror, of the plurality of mirrors, includes at least a threshold area that is usable to provide an optical path without the optical path intersecting with any other mirror of the plurality of mirrors.

7. The optical component of claim 1, wherein a first beam path directed toward a mirror, of the plurality of mirrors, is parallel to the single, horizontal plane and a second beam path, reflected from the mirror, of the plurality of mirrors, is non-orthogonally angled to the single, horizontal plane.

8. The optical component of claim 1, wherein a first beam path reflected from a mirror, of the plurality of mirrors, is parallel to the single, horizontal plane and a second beam path, directed toward the mirror, of the plurality of mirrors, is non-orthogonally angled to the single, horizontal plane.

9. The optical component of claim 1, wherein the optical component is a spatial beam combiner.

10. An optical module, comprising:
a substrate;
a plurality of mirrors disposed on a top surface of the substrate,
wherein each mirror, of the plurality of mirrors, is angled with respect to a plane of the top surface of the substrate, such that each optical path associated with each mirror is disposed in a corresponding tilted plane that is non-parallel with and non-orthogonal to the plane of the top surface of the substrate; and
one or more optical components to form a set of optical paths that includes each optical path associated with each mirror.

11. The optical module of claim 10, wherein the one or more optical components include at least one of:
a common folding mirror,
a polarization beam combiner,
a coupling lens,
a fast axis collimator,
a slow axis collimator, or
a fiber bulkhead.

12. The optical module of claim 10, wherein at least one optical component, of the one or more optical components, is angled, non-orthogonally, with respect to the plane of the top surface of the substrate.

13. The optical module of claim 10, further comprising at least one of:
a spatial beam combiner,
a wavelength locked module, or
a volume Bragg grating.

14. The optical module of claim 10, wherein the substrate comprises:
a plurality of chips,
each chip, of the plurality of chips, associated with a corresponding mirror of the plurality of mirrors.

15. The optical module of claim 14, wherein each chip, of the plurality of chips, is mounted to a package in the same horizontal plane.

16. The optical module of claim 10, wherein the plurality of mirrors is a first plurality of mirrors forming a first bank, and wherein the optical module further comprises:
a second plurality of mirrors forming a second bank,
each mirror, of the second plurality of mirrors, is angled with respect to the plane of the top surface of the substrate.

17. The optical module of claim 16, wherein the first bank is at a first height above a base to which the substrate is attached, and
wherein the second bank is at a second height above the base.

18. An optical component, comprising:
a base; and
a plurality of mirrors disposed on the base in a single, horizontal plane,
wherein each mirror, of the plurality of mirrors, is angled, non-orthogonally, with respect to the single, horizontal plane, such that each optical path associated with each mirror is disposed in a corresponding tilted plane that is non-parallel with the single, horizontal plane, and
wherein each optical path, associated with each mirror, is parallel to each other optical path.

19. The optical component of claim 18, wherein a tilting angle of each mirror is associated with a pitch of each mirror.

20. The optical component of claim 18, further comprising:
a plurality of chip on submount (COS) components aligned to the plurality of mirrors and mounted in the single, horizontal plane.
